(19) United States
(12) Patent Application Publication
(10) Pub. No.: US 2003/0001495 A1
(43) Pub. Date: Jan. 2, 2003

(54) Pink light-emitting device

(75) Inventors: Ru-Shi Liu, Chu-Tung Town (TW); Chien-Yuan Wang, Kang-Shan Town (TW); R.K. Wu, Fong-Shan (TW); Jingren Shih, Taipei (TW)

Correspondence Address: Ladas & Parry, 26 West 61st Street, New York, NY, 10023, US

(73) Assignee: NANTEX INDUSTRY CO., LTD.

(21) Appl. No.: 10/037,581

(22) Filed: Jan. 4, 2002

(30) Foreign Application Priority Data
Jun. 27, 2001 (TW) 090115614

(51) Int. Cl. H05B 33/02

(52) U.S. Cl. 313/512

(57) ABSTRACT

The subject invention relates to a pink light-emitting device with high brightness, which comprises a light-emitting diode as a luminescent element and a fluorescent body containing yttrium aluminum garnet fluorescent powders with formula of (Y_{3-x-y}CeₓZ_{y})Al₅O₁₂ or (Y₃CeₓZ_{y})Al₅O₁₂, wherein said light-emitting element emits a purple to blue light with a wavelength ranging from 400 nm to 450 nm, 0<x≦0.8, 0.5<y≦2.5, and Z is selected from a group consisting of rare earth metals other than cerium (Ce).

### FIELD OF THE INVENTION

The present invention relates to a pink light-emitting device, particularly to a pink light-emitting device comprising a light-emitting diode and a fluorescent body.

### BACKGROUND OF THE INVENTION

Light-emitting diode (LED) has numerous advantages over conventional light sources, including minimized volume, excellent light-emitting efficiency, long life (up to a hundred thousand hours), no need to warm up, high operation response speed, high reliability, breakage resistance, high flexibility to comply with application requirements to produce minimized or matrix elements, no heat radiation, and no pollution of toxins such as mercury. Furthermore, after the association of the LED and appropriate fluorescent powders, a white LED is produced by mixing colored lights. Such white LED can be operated at lower voltage and current (about 20 mA), and provides color temperature (8000K) that is comparable to sun light and has a color rendering close to high performance fluorescent lumps (three-wavelength type).

The LED has initially been commercialized since 1968. However, the full color LED have been realized when NICHIA Company (Japan) successfully developed higher efficient GaInN series blue LEDs in 1993. Although LEDs of certain colors such as yellow or orange LEDs have been developed, it is still impossible to produce pink LEDs. Accordingly, pink LEDs are highly desired.

### SUMMARY OF THE INVENTION

The object of the present invention is to provide a pink light-emitting device, which comprises a light-emitting diode as a luminescent element and a fluorescent body containing yttrium aluminum garnet fluorescent powders, wherein the diode emits a light with a wavelength ranging from 400 nm to 450 nm, and the light then excites the yttrium aluminum garnet fluorescent powders in the fluorescent body to emit another light with a wavelength ranging from 575 nm to 585 nm, so the two lights combine to produce a pink light with uniformly distributed colors.

### BRIEF DESCRIPTION OF DRAWINGS

FIG. 1 shows X ray powder diffraction spectra for the yttrium aluminum garnet fluorescent body of Example 3 with a formula (Y_{3-x-y}CeₓGd_{y})Al₅O₁₂, wherein x is 0.05, and y is 1.2, 1.8 and 2.4, respectively.

FIG. 2 shows emission spectra of the yttrium aluminum garnet fluorescent bodies of Example 3 detected by a light having a wavelength of 450 nm as a luminizing source.

FIG. 3 shows that dashed lines, separately drawn from the chromaticities of points A, B, and C (calculated from the emission spectra of FIG. 2) representing a fluorescent body to the chromaticity of point D representing a light with wavelength of 450 nm, passes the pink area in the Chromaticity diagram.

### DETAILED DESCRIPTION OF THE INVENTION

By way of illustration and to provide a more complete appreciation of the present invention with many of the attendant advantages thereof, the following detailed description is given concerning yttrium aluminum garnet fluorescent powders, its preparation and its use in a light-emitting device.

The present invention relates to yttrium aluminum garnet fluorescent powders with formula (Y_{3-x-y}CeₓZ_{y})Al₅O₁₂ or (Y₃CeₓZ_{y})Al₅O₁₂, wherein 0<x≦0.8, 0.5<y≦2.5, and Z is selected from a group consisting of rare earth metals other than cerium (Ce). The rare earth metals other than cerium comprise gadolinium (Gd), praseodymium (Pr), neodymium (Nd), promethium (Pm), samarium (Sm), terbium (Tb), dysprosium (Dy), holmium (Ho), erbium (Er), thulium (Tm), ytterbium (Yb), and lutetium (Lu). Preferably, in the formula (Y_{3-x-y}CeₓZ_{y})Al₅O₁₂ or (Y₃CeₓZ_{y})Al₅O₁₂, 0<x≦0.4, 1.0<y≦2.5, and Z is gadolinium (Gd). Since the fluorescent powder of the invention contains at least two optically active centers (cerium and rare earth metals other than cerium), it is possible to adjust the components of the composition or their ratios to obtain pink light having broader color spectrum as well as excellent light-emitting properties such as highly uniform color and high brightness. Specifically, as being excited by a light-emitting diode capable of emitting a purple to blue light with a wavelength ranging from 400 nm to 450 nm, the fluorescent powders of the present invention emit an orange-yellow to red light with a wavelength ranging from 575 nm to 585 nm. The two lights combine to produce a pink light with uniformly distributed colors.

The fluorescent powders of the invention can be produced by any conventional processes for the preparation of fluorescent powders. The processes include solid-state reaction processes and chemical synthesis processes. Among them, a solid-state reaction process includes the step of mixing metal-containing materials in desired ratios. The mixture is subject to the treatments of grinding, pyrolysis, calcination, sintering, and reduction to produce fluorescent powders. However, the uniformity of the fluorescent powders thus obtained is poor and their particle sizes are large and not uniform. On the contrary, chemical synthesis processes provide fluorescent powders having desired purity, uniformity, and particle sizes. Hence, chemical synthesis processes, particularly gelation process and co-precipitation process, are preferred for the preparation of the fluorescent powders of the invention.

The gelation process for the preparation of the fluorescent powders of the invention comprises the steps of (1) grinding and homogeneously mixing water soluble compounds containing desired metals in ratios as those of the metals in the desired fluorescent powders to obtain a metal powder mixture, (2) dissolving the powder mixture in water to form an aqueous solution, (3) adding an appropriate amount of a chelating agent into the aqueous solution to chelate the metals in the aqueous solution, (4) adjusting the pH value of the aqueous solution to equal to or greater than 3 and converting the aqueous solution into a viscous liquid thereby, (5) pyrolyzing the viscous liquid to an ash, (6) calcining the ash, and (7) sintering the calcined ash.

The compounds used in step (1) can be any appropriate compounds, for example, the salts or organic compounds of the desired metals.

The water used in step (2) is preferably de-ionized water, more preferably secondary de-ionized water.

The chelating agent used in step (3) is an organic or inorganic compound which can form a chelate with the selected metals. Suitable chelating agents include, but are not limited to, organic acids, for example citric acid.

In step (4), a base is added to the aqueous solution to adjust its pH value to be equal to or greater than 3, preferably equal to or greater than 7, and more preferably equal to or greater than 10. The base can be an organic base, inorganic base and the like. Suitable organic bases include, but are not limited to, amines, for example, ethylenediamine. Suitable inorganic bases include, but are not limited to, ammonia liquor.

In step (4), after adjusting the pH value of the solution as desired, any appropriate manners can be used to accelerate the formation of a viscous liquid. For example, a heating treatment in combination with stirring can be used to accelerate the formation, wherein the heating temperature is preferably no higher than 120° C.

In step (5), the pyrolysis can be carried out in air. The selection of the pyrolysis temperature depends on the species of involved metals and the purpose that most of the organic substances and part of nitrogen oxides in the viscous liquid can be decomposed. Generally, the pyrolysis temperature is no higher than 400° C., for example, 300° C. A cooling step is optionally used to cool the viscous liquid to a gel prior to step (5).

The calcining in step (6) and sintering in step (7) are conventional in the art. Depending on the selected metals, skilled artisans can choose appropriate temperature, time and heating/cooling rate to practice the steps. For example, for the preparation of (Y_{0.55}Ce_{0.05}Gd_{2.4})Al₅O₁₂, the calcining temperature can be from 900° C. to 1200° C., such as 1000° C.; the sintering temperature can be from 1200° C. to 1600° C., such as 1500° C. Both the calcining and sintering can be carried out in air. The heating/cooling rate can be between 1° C./min and 10° C./min, such as 5° C./min. The calcined ash of step (6) can be optionally grounded before step (7).

After step (7), the sintered powder can be optionally reduced in a reducing atmosphere at an elevated temperature. The reducing atmosphere can be any appropriate gas or gas mixture. For example, the reducing atmosphere can be a mixture of hydrogen and nitrogen in an optional ratio such as H₂/N₂ (5%/95%). Skilled artisans can select appropriate reduction temperature and time to practice the reduction. The reduction temperature typically ranges from 1300° C. to 1550° C., such as 1500° C., and the reduction time typically ranges from 6 to 18 hours, such as 12 hours.

The co-precipitation process for the preparation of the fluorescent powder of the invention comprises the steps of (1) grinding and homogeneously mixing water soluble compounds containing desired metals in ratios as those in the desired fluorescent powders to obtain a metal powder mixture, (2) dissolving the powder mixture in water to form an aqueous solution, (3) adjusting the pH value of the aqueous solution to equal to or greater than 7 and converting the aqueous solution into a gel thereby, (4) pyrolyzing the gel to an ash, (5) calcining the ash, and (6) sintering the calcined ash.

The compounds used in step (1) can be any appropriate compounds, for example, the salts or organic compounds of the desired metals.

The water used in step (2) is preferably de-ionized water, more preferably secondary de-ionized water.

In step (3), a base is added to the aqueous solution to adjust its pH value to equal to or greater than 3, preferably equal to or greater than 7, and more preferably equal to or greater than 10. The base can be an organic base, inorganic base and the like. Suitable organic bases include, but are not limited to, amines, for example, ethylenediamine. Suitable inorganic bases include, but are not limited to, ammonia liquor.

In step (3), after adjusting the pH value of the solution as desired, any appropriate manners such as mixing can be used to accelerate the gel formation. A filtration operation optionally in combination with suction can facilitate the formation of gel.

In step (4), the pyrolysis can be carried out in air. The selection of the pyrolysis temperature depends on the species of involved metals and the purpose that most organic substances and part of nitrogen oxides in the gel can be decomposed. Generally, the pyrolysis temperature is no higher than 400° C., for example, 300° C.

The calcined ash obtained in step (5) can be optionally ground prior to step (6).

The calcining in step (5) and sintering in step (6) are conventional in the art. Depending on the selected metals, skilled artisans can choose appropriate temperature, time and heating/cooling rate to practice the steps. For example, for the preparation of (Y_{0.55}Ce_{0.05}Gd_{2.4})Al₅O₁₂, the calcining temperature can be from 900° C. to 1200° C., such as 1000° C.; the sintering temperature can be from 1200° C. to 1600° C., such as 1500° C. Both the calcining and sintering can be carried out in air. The heating/cooling rate can be between 1° C./min and 10° C./min, such as 5° C./min.

After step (6), the sintered powder can be optionally reduced in a reducing atmosphere at an elevated temperature. The reducing atmosphere can be any appropriate gas or gas mixture. For example, the reducing atmosphere can be a mixture of hydrogen and nitrogen in an optionally selected ratio such as H₂/N₂ (5%/95%). The skilled artisans can select appropriate reduction temperature and time to practice the reduction. The reduction temperature typically ranges from 1300° C. to 1550° C., such as 1500° C., and the reduction time typically ranges from 6 to 18 hours, such as 12 hours.

By adjusting the composition of the metal powder mixture in step (1), the gelation process and co-precipitation process can be used to produce any desired fluorescent powders of the invention. The products thus obtained have finer and more uniform particles in comparison with those prepared by solid-state reaction processes.

The subject invention also relates to a pink light-emitting device, which comprises a purple to blue light-emitting diode as a luminescent element and a fluorescent body comprising yttrium aluminum garnet fluorescent powders with formula (Y_{3-x-y}CeₓZ_{y})Al₅O₁₂ or (Y₃CeₓZ_{y})Al₅O₁₂, wherein 0<x≦0.8, 0.5<y≦2.5, and Z is selected from a group consisting of rare earth metals other than cerium (Ce). The elements of rare earth metal other than cerium comprise gadolinium (Gd), praseodymium (Pr), neodymium (Nd), promethium (Pm), samarium (Sm), terbium (Tb), dysprosium (Dy), holmium (Ho), erbium (Er), thulium (Tm), ytterbium (Yb), and lutetium (Lu). Preferably, in the formula (Y_{3-x-y}CeₓZ_{y} )Al₅O₁₂ or (Y₃CeₓZ_{y})Al₅O₁₂, 0<x≦0.4, 1.0 ≦y≦2.5, and Z is gadolinium (Gd).

In the pink light-emitting device of the invention, a light-emitting diode emits a purple to blue light with a wavelength ranging from 400 nm to 450 nm, wherein the light excites the yttrium aluminum garnet fluorescent powders to emit an orange-yellow to orange light with a wavelength ranging from 575 nm to 585 nm. The above two lights combine to produce a pink light.

For example, in a fluorescent body produced from yttrium aluminum garnet fluorescent powders containing cerium and gadolinium (Gd), the fluorescent body is excited by a light-emitting diode, which emits a purple to blue light with a wavelength ranging from 400 nm to 450 nm, to emit an orange-yellow to orange light with a wavelength ranging from 575 nm to 585 nm. The purple to blue light combines with the orange-yellow to orange light to provide a pink light with uniformly distributed colors and its brightness is higher than that provided by a fluorescent body from fluorescent powders only containing europium but not gadolinium. For testing the optical properties of fluorescent materials, a photoluminescence spectrometer is used to conduct the scan of the luminescence spectrum of a fluorescent body, and then a luminescence wavelength for scanning the emission spectra is determined based on the luminescence spectrum. The yttrium aluminum garnet fluorescent body of the invention comprising at least two optically active centers is susceptible to be excited by a purple to blue light with wavelength ranging from 400 nm to 450 nm to emit an orange-yellow to orange light with a wavelength ranging from 575 nm to 585 nm. When looking at the fluorescent body, one can sense a pink light with high brightness. This is because when visual nerves are stimulated simultaneously by two lights with different wavelengths, one can sense a new color different from those of the light sources. The chromaticity of the color, expressed as (x,y), can be calculated from the relative strength of light in view of the line drawn between two chromaticities of the wavelengths of original lights. Therefore, by utilizing conventional technology, the fluorescent powders of the invention can be supported or fixed by an appropriate material to form a fluorescent body. The fluorescent body associated with a light-emitting diode as a light source for emitting a wavelength ranging from 400 nm to 450 nm can be applied with an appropriate current to provide a pink light-emitting diode with excellent light-emitting properties.

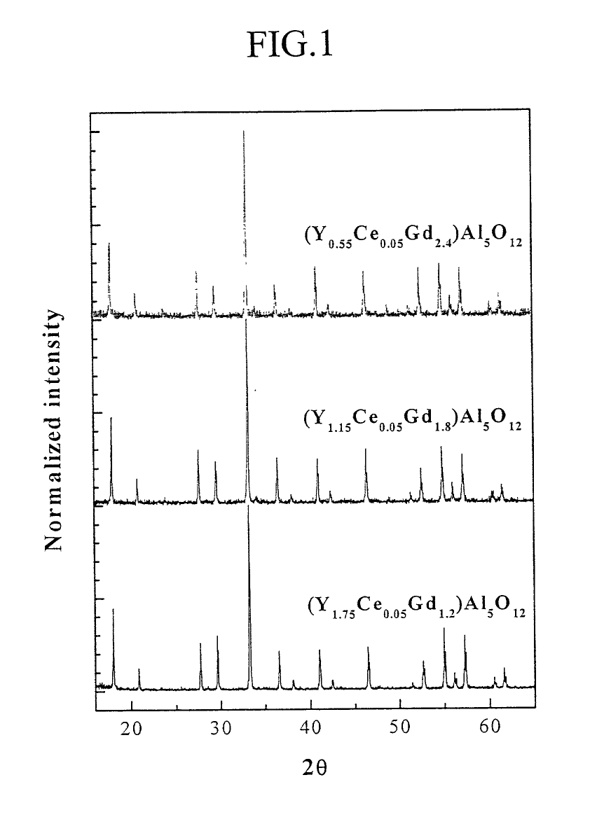

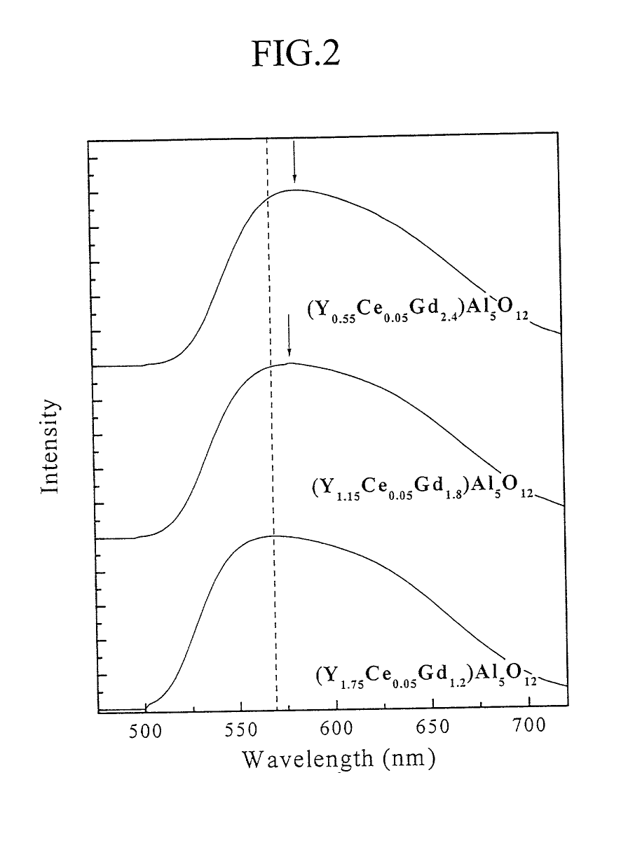

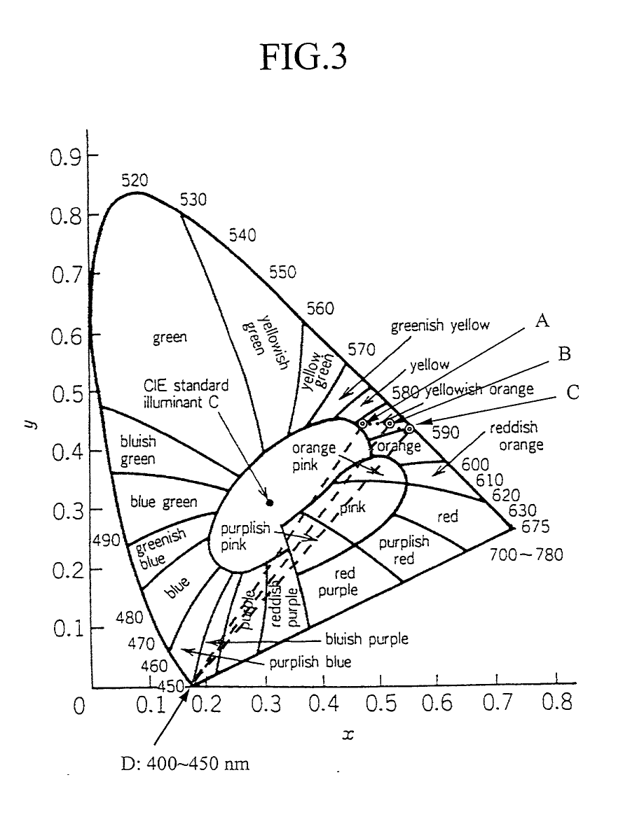

Referring to FIG. 1, the X ray powder diffraction spectra for yttrium aluminum garnet fluorescent bodies of Example 3 with a formula (Y_{3-x-y}CeₓGd_{y})Al₅O₁₂ (wherein x=0.05, and y is 1.2, 1.8 and 2.4, respectively) are provided. As shown in FIG. 1, after comparing with a standard X ray powder diffraction spectrum of a yttrium aluminum garnet fluorescent body having a formula Y₃Al₅O₁₂, it is found that the synthesized products are all pure phases. Since the components of the fluorescent powders closely correlate to the luminescence efficiency of the powders, the fluorescent powders produced by the process of the invention actually meets the requirement of having a pure phase. FIG. 2 is an emission spectrum of a fluorescent powder of the above (Y_{3-x-y}CeₓGd_{y})Al₅O₁₂ detected by a light having a wavelength of 450 nm as a exciting source. As shown in FIG. 2, the more gadolinium replaces yttrium in the fluorescent powders, the more the fluorescent wavelength distribution of the powder shifts to the longer wavelength range, and this is so-called red shift. FIG. 3 shows that the data of the emission spectra are converted to chromaticities of the fluorescent bodies by the formula of Chromaticity diagram ruled by Commission Internationale de l'Eclairage (CIE) in 1931. The chromaticities of the fluorescent powders with a formula (Y_{3-x-y}CeₓGd_{y})Al₅O₁₂ wherein x is 0.05 and y is 1.2, 1.8 and 2.4, are respectively marked as points A, B and C, and the chromaticity (0.1738, 0.0049) of a light with a wavelength of 450 nm is marked as D. Dashed lines are drawn from points A, B and C to D, respectively. As shown in FIG. 3, it is found that the dashed lines pass the pink area in the Chromaticity diagram. In other words, according to the principle of the combination of colors and lights, when visual nerves are simultaneously stimulated by a light with a wavelength ranging from 450 nm and an orange-yellow or orange light (point A, B, or C), a pink vision is generated. It is noted that the use of conventional fluorescent powders having a single luminescence center such as (Y₃₋ₓEuₓ)Al₅O₁₂ in combination with a purple or blue-light emitting diode cannot provide a light source whose chromaticity falling within the left half part of the pink area. The components of the fluorescent powders are obviously important. Hence, a pink light-emitting diode with excellent luminescence properties can be produced by mixing the fluorescent powders of the invention and suitable materials in appropriate proportion, utilizing a purple or blue light-emitting diode as a light source for emitting an appropriate wavelength, properly packaging the mixture and diode, and applying a proper current.

The following examples are provided to further explain the invention from which the artisans can further appreciate the invention. However, the examples should not be considered as a limitation to the scope of the invention.

### EXAMPLE 1

### Solid-State Reaction Process

To provide a formulation wherein Y:Ce:Gd:Al=0.55:0.05:2.4:5, [Y(NO₃)₃.6H₂O] (0.4021g), [Al(NO₃)₃.9H₂O] (3.5748g), [Ce(NO₃)₃.6H₂O] (0.0418g) and [Gd(NO₃)₃.5H₂O] (1.9824g) were stoichiometrically mixed. The raw material was ground and homogeneously mixed to form a powder mixture. The powder mixture was put in a crucible and heated in air 1000° C. at a heating rate of 5° C./min to effect calcination. After 24 hours, the powder was cooled to room temperature at a cooling rate of 5° C./min.

The calcinated powder was ground and put in a crucible and sintered in air at 1500° C. for 24 hours. The heating and cooling rate of the sintering step were 5° C./min.

The sintered powder was ground and optionally reduced in a reducing atmosphere of H₂/N₂ (5%/95%) at 1500° C. for 12 hours. The reduction step is to reduce Ce⁴⁺ to Ce³⁻ so as to improve the brightness of the powder. Finally, the powder was cooled to room temperature to obtain a fluorescent powder with a formula of (Y_{0.55}Ce_{0.05}Gd_{2.4})Al₅O₁₂.

### EXAMPLE 2

### Gelation Process

To provide a formulation wherein Y:Ce:Gd:Al=0.55:0.05:2.4:5, [Y(NO₃)₃.6H₂O] (0.4021g), [Al(NO₃)₃.9H₂O] (3.5748g), [Ce(NO₃)₃.6H₂O] (0.0418g) and [Gd(NO₃)₃.5H₂O] (1.9824g) were stoichiometrically mixed. The salt mixture was dissolved in secondary de-ionized water to form an aqueous solution.

Citric acid, as a chelating agent, was added to the aqueous solution in molars the same as those of the metal ions in the aqueous solution. A base such as ammonia liquor or ethylenediamine was added to the aqueous solution to adjust the pH value of the aqueous solution to 10.5. The aqueous solution was heated at 100 to 120° C. to form a viscous liquid. The viscous liquid was cooled to form a gel. The gel was heated at 300° C. to decompose most of the organic substance and part of nitrogen oxide in the gel to provide a dark blown ash.

The ash was put in a crucible and heated in air to 1000° C. at a heating rate of 5° C./min to effect calcination to form powders. After 24 hours, the powder was cooled to room temperature at a cooling rate of 5° C./min. The calcinated powders were put in a crucible and sintered in air at 1500° C. for 24 hours. The heating rate and cooling rate of the sintering step were 5° C. /min.

The sintered powder was optionally reduced in a reducing atmosphere of H₂/N₂ (5%/95%) at 1500° C. for 12 hours. The reduction step is to reduce Ce⁴⁺ to Ce³⁻ so as to improve the brightness of the powders. Finally, the powder was cooled to room temperature to obtain a fluorescent powder with a formula of (Y_{0.55}Ce_{0.05}Gd_{2.4})Al₅O₁₂.

### EXAMPLE 3

### Co-Precipitation Process

To provide a formulation wherein Y:Ce:Gd:Al=0.55:0.05:2.4:5, [Y(NO₃)₃.6H₂O] (0.4021g), [Al(NO₃)₃.9H₂O] (3.5748g), [Ce(NO₃)₃6H₂O] (0.0418g) and [Gd(NO₃)₃.5H₂O] (1.9824g) were stoichiometrically mixed. The salt mixture was dissolved in secondary de-ionized water to form an aqueous solution.

A base such as ammonia water or ethylenediamine was added in the aqueous solution to adjust the pH value of the aqueous solution to 10.5. The solution was stirred to form a gel solution and then filtered with suction to provide a white gel. The white gel was heated in air at 300° C. to decompose most of the organic substance and part of nitrogen oxide in the gel to provide a dark brown ash.

The ash was put in a crucible and heated in air to 1000° C. at a heating rate of 5° C./min to effect calcination to form powders. After 24 hours, the powders were cooled to room temperature at a cooling rate of 5° C./min. The calcinated powders were put in a crucible and sintered in air at 1500° C. for 24 hours. The heating rate and cooling rate during the sintering step were 5° C./min.

The sintered powders were optionally reduced in a reducing atmosphere of H₂/N₂ (5%/95%) at 1500° C. for 12 hours to reduce Ce⁴⁺ to Ce³⁺ so as to improve the brightness of the powder.

Finally, the powder was cooled to room temperature to obtain a fluorescent body with a formula of (Y_{0.55}Ce_{0.05}Gd_{2.4})Al₅O₁₂. The body was ground by a mortar in a crucible. The fluorescent body was tested by an X ray powder diffraction to evaluate if its crystal structure is pure phase, and then determined by a photoluminescence spectrometer for its light-emitting properties.

The above steps were repeated, with the exception that the amounts of [Y(NO₃)₃.6H₂O] and [Gd(NO₃)₃.5H₂O] were changed so that the stoichiometrical ratios of Y:Ce:Gd:Al were 1.75:0.05:1.2:5 and 1.15:0.05:1.8:5, respectively, to produce fluorescent powders having a formula of (Y_{1.75}Ce_{0.05}Gd_{1.2})Al₅O₁₂ or (Y_{1.15}Ce_{0.05}Gd_{1.8})Al₅O₁₂. The light-emitting properties of the florescent powders thus produced were also determined.

The present invention may, of course, be carried out in other specific ways than those herein before described without departing from the spirit and essential characteristics of the present invention. The present embodiments are, therefore, to be considered in all respects as an illustration and not restrictive. Therefore, any changes coming within fluorescent bodies produced from a yttrium aluminum garnet having at least two optically active centers in the main lattice to provide excellent light-emitting properties such as a high uniformity in color and high brightness are to be embraced therein.

What is claimed is:

1. A pink light-emitting device with high brightness comprising a light-emitting diode as a luminescent element and a fluorescent body comprising yttrium aluminum garnet fluorescent powders with formula of (Y_{3-x-y}CeₓZ_{y})Al₅O₁₂ or (Y₃CeₓZ_{y})Al₅O₂, wherein said light-emitting element emits a purple to blue light with a wavelength ranging from 400 nm to 450 nm, 0<x≦0.8, 0.5<y≦2.5, and Z is selected from a group consisting of rare earth metals other than cerium (Ce).

2. A pink light-emitting device according to claim 1, wherein said rare earth metals other than cerium comprises gadolinium (Gd), praseodymium (Pr), neodymium (Nd), promethium (Pm), samarium (Sm), terbium (Tb), dysprosium (Dy), holmium (Ho), erbium (Er), thulium (Tm), ytterbium (Yb), or lutetium (Lu).

3. A pink light-emitting device according to claim 1, wherein Z is gadolinium.

4. A pink light-emitting device according to claim 1, wherein said fluorescent powder is excited by a purple to blue light to emit an orange-yellow to orange light with a wavelength ranging from 575 nm to 585 nm.

5. A pink light-emitting device according to claim 1, said yttrium aluminum garnet fluorescent powder is prepared by a process comprising the steps of (1) grinding and homogeneously mixing water soluble compounds containing desired metals in desired ratios as those of the metals in the fluorescent powder to provide a metal powder mixture, (2) dissolving the powder mixture in water to form an aqueous solution, (3) adjusting the pH value of the aqueous solution to equal to or greater than 3, and converting the aqueous solution into a gel thereby, (4) pyrolyzing the gel to an ash, (5) calcining the ash, and (6) sintering the calcined ash to form the fluorescent powder.
